(19) United States
(12) Patent Application Publication
(10) Pub. No.: US 2010/0128025 A1
(43) Pub. Date: May 27, 2010

(54) METHOD OF MANUFACTURING AND DRIVING OCB LIQUID CRYSTAL PANEL

(75) Inventors: Ze-Yu Yen, Taipei City (TW); Ding-Jen Chen, Chiayi County (TW); Jian-Lung Chen, Taoyuan County (TW); Cho-Ying Lin, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: TAIWAN TFT LCD ASSOCIATION, Hsinchu (TW); CHUNGHWA PICTURE TUBES, LTD., Taoyuan (TW); AU OPTRONICS CORPORATION, Hsinchu (TW); HANNSTAR DISPLAY CORPORATION, Taipei City (TW); CHI MEI OPTOELECTRONICS CORPORATION, Tainan County (TW); INDUSTRIAL TECHNOLOGY RESEARCH INSTITUTE, Hsinchu (TW)

(21) Appl. No.: 12/485,899

(22) Filed: Jun. 16, 2009

(30) Foreign Application Priority Data
Nov. 21, 2008 (TW) 97145200

(51) Int. Cl. G02F 1/1337; G09G 5/00; G02F 1/133

(52) U.S. Cl. 345/214; 349/33; 349/191; 345/87

(57) ABSTRACT

A method of manufacturing and driving an optically compensated birefringence (OCB) mode liquid crystal (LC) panel is provided. In the method, the OCB LC panel is applied which is characterized that a closed structure region with HAN, VA or Bend property is around a display region of the OCB LC panel. Thereafter, the OCB LC panel is driven by a mode of multistage voltage variation. The mode of multistage voltage variation includes applying a high voltage to LC molecules in the OCB LC panel for transferring them to a bend or a VA state, decaying the high voltage to a low voltage above a bend state holding voltage of the OCB LC panel, and turning off the voltage to zero so as to maintain the configuration of LC molecules in the OCB LC panel in a π-twist state.

### CROSS-REFERENCE TO RELATED APPLICATION

This application claims the priority benefit of Taiwan application serial no. 97145200, filed on Nov. 21, 2008. The entirety of the above-mentioned patent application is hereby incorporated by reference herein and made a part of this specification.

### BACKGROUND OF THE INVENTION

1. Field of the Invention

The present invention relates to a method of manufacturing and driving an optically compensated birefringence (OCB) liquid crystal panel, by which a transition process from a splay state to a bend state is omitted when the OCB liquid crystal panel is driven.

2. Description of Related Art

To supply a quality demand of dynamic images of a liquid crystal display (LCD), various fast-response LCD techniques are continuously provided, and one of those is an OCB type display mode.

One of disadvantages of an OCB liquid crystal panel is that transition from a splay state to a bend state is necessary for driving the OCB liquid crystal panel, so that the OCB liquid crystal panel requires a high voltage to perform the transition for starting a display driving. However, the relatively high voltage not only increases a cost of the liquid crystal panel, but may also cause damage to the liquid crystal panel.

According to some seed techniques, the OCB liquid crystal panel is allowed to perform the transition under a relatively low voltage, for example, a U.S. Pat. No. 7,215,397B2 filed in 2002. However, such technique still requires the relatively high voltage to transit liquid crystal molecules from the splay state to the bend state. Moreover, a plurality of etching and developing processes, etc. are required to be additionally added, so that a manufacturing process thereof is relatively complicated. Therefore, the OCB display mode still cannot be practical according to the current seed techniques.

Generally, states of liquid crystal molecules within a conventional OCB liquid crystal cell before and after being driven are shown in FIG. 1. Before a voltage is applied, an arrangement direction of the liquid crystal molecules 100 is in a splay state along with an alignment direction of a substrate 110. After being driven by the voltage, the liquid crystal molecules 100 are changed to a Bend I state, and then are changed to a Bend II state. Once the voltage is turned off, the arrangement of the liquid crystal molecules is first maintained to a π-twist state, and then is slowly changed to the splay state. Since a free energy of the π-twist state is closed to that of the bend states (Bend I and Bend II), if the liquid crystal molecules 100 can be maintained to the π-twist state before being driven, they are more easily to be driven to the bend state compared to a case that the liquid crystal molecules 100 are driven to the bend state from the splay state.

In 2006, the Pusan National University discloses a two mode OCB design in Applied Physics Letters 89, 123507 (2006), in which chiral molecules are added to the liquid crystal to maintain the OCB structure in the π-twist state for forming a memory state, so as to achieve a dynamic mode and a memory mode by applying a side electrode and a vertical electrode. However, such method has to use the chiral liquid crystal, which can generally influence a photoelectric characteristic of the liquid crystal panel.

Moreover, in 2007, a technique disclosed by the Pusan National University in the Applied Physics Letters 90, 163513 (2007) provides a method of maintaining the liquid crystal molecules to the π-twist state based on phase separation of the liquid crystal molecules and a fluorinated polymer material, by which use of the chiral molecules is unnecessary. However, when the liquid crystal molecules and the fluorinated polymer material are mixed and further separated, the photoelectric characteristic of the liquid crystal panel can be influenced.

### SUMMARY OF THE INVENTION

The present invention is directed to a method of manufacturing and driving an OCB liquid crystal panel, by which a transition process from a splay state to a bend state is omitted when the OCB liquid crystal panel is driven.

The present invention provides a method of manufacturing and driving an OCB liquid crystal panel. In the method, the OCB liquid crystal panel is provided, and the OCB liquid crystal panel has a closed structure region having a hybrid arrangement (HAN), a vertical arrangement (VA) or a bend arrangement property around a display region of the OCB liquid crystal panel. The OCB liquid crystal panel is driven by a multistage voltage variation mode. The mode of multistage voltage variation includes applying a high voltage to transfer liquid crystal molecules in the OCB liquid crystal panel to a bend or a vertical arrangement state, decaying the high voltage to a low voltage, wherein the low voltage is maintained above a bend state holding voltage of the OCB liquid crystal panel, and turning off the voltage to zero to maintain the configuration of liquid crystal molecules in the OCB liquid crystal panel in a π-twist state.

In the present invention, the liquid crystal molecules of the display region are maintained to the π-twist state according to a structure design of an alignment surface and a specific driving method, so as to produce the OCB liquid crystal panel without the transition of the liquid crystal molecules from the splay state to the bend state.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating states of liquid crystal molecules within a conventional OCB liquid crystal cell before and after being driven.

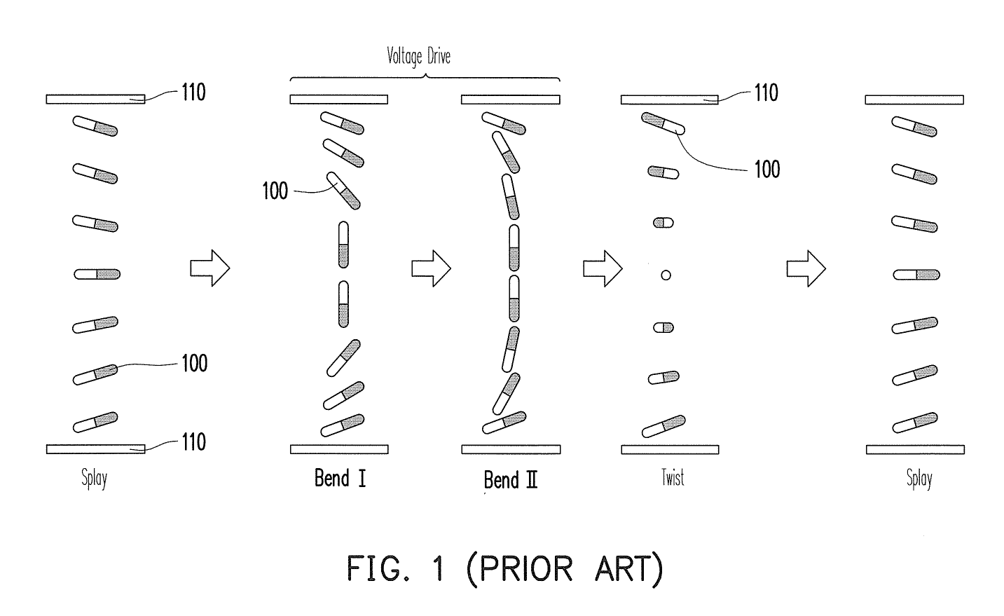

FIG. 2 is a flowchart illustrating driving steps of an OCB liquid crystal panel according to an embodiment of the present invention.

FIG. 3 is a diagram illustrating a structure formed according to a step 200 of an embodiment of the present invention.

FIG. 4 is a schematic diagram illustrating a state of the liquid crystal molecules in a closed structure formed according to a step 200 of an embodiment of the present invention.

FIGS. 5-7 are diagrams illustrating curves of a multistage voltage variation control according to a step 210 of an embodiment of the present invention.

FIG. 8 is a diagram illustrating a voltage-transmittance (V-T) curve obtained according to Example 2.

FIG. 9 is a diagram illustrating a V-T curve obtained according to Example 3.

### DESCRIPTION OF EMBODIMENTS

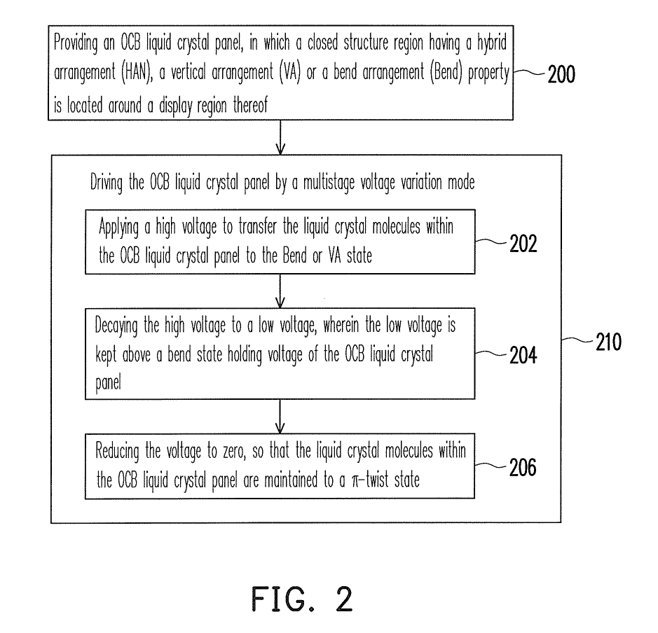

FIG. 2 is a flowchart illustrating driving steps of an OCB liquid crystal panel according to an embodiment of the present invention.

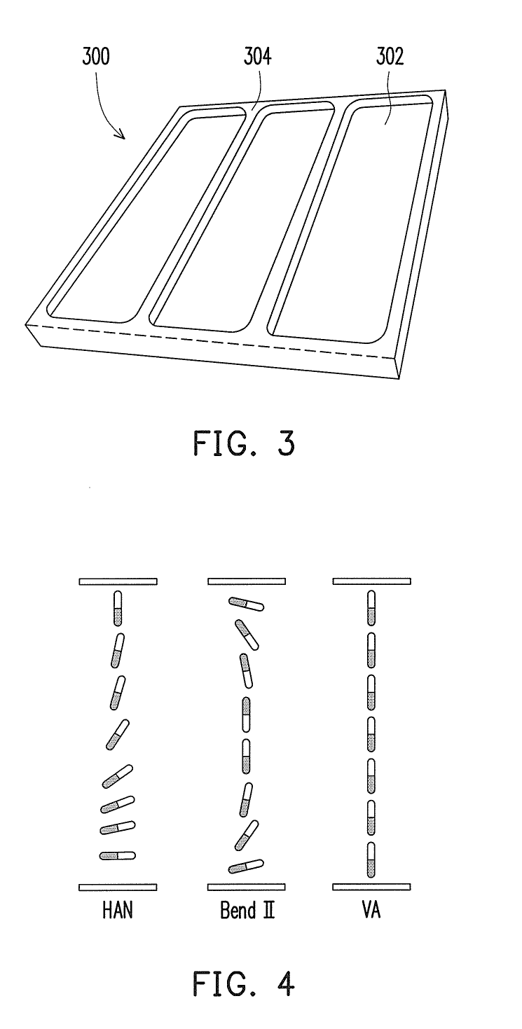

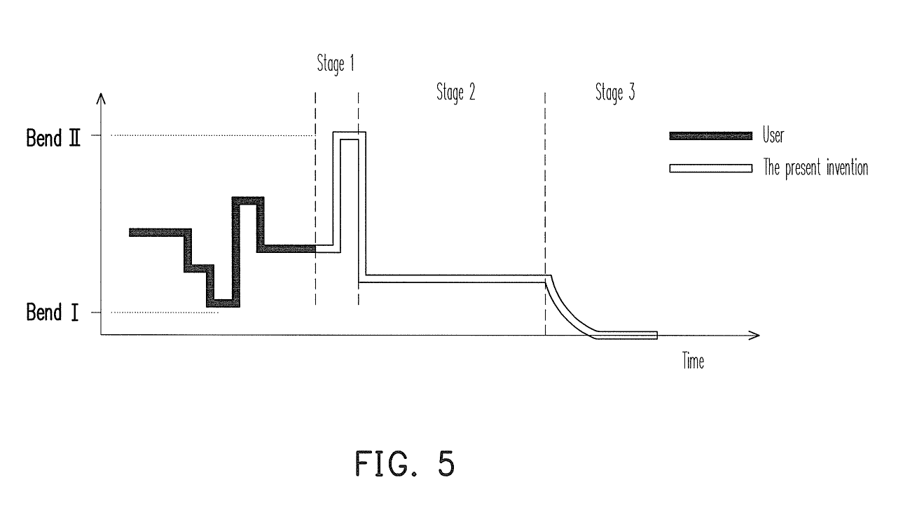

Referring to FIG. 2, in step 200, an OCB liquid crystal panel is provided, in which a closed structure region having a hybrid arrangement (HAN), a vertical arrangement (VA) or a bend arrangement (Bend) property is located around a display region thereof. The above OCB liquid crystal panel can be manufactured according to current technique. For example, a reactive liquid crystal monomer layer is formed on an alignment-treated surface of an upper substrate and/or an alignment-treated surface of a lower substrate based on spin coating, screen printing, offset printing, ink-jet printing, slot die coating or nano-imprinting, for example. After the reactive liquid crystal monomer layer is polymerised to a liquid crystal polymer pattern, the liquid crystal may behave horizontal arrangement or vertical arrangement. Thereafter, exposure polymerization and development of the reactive liquid crystal monomer layer are performed to form a structure shown as FIG. 3. In FIG. 3, the surface of an upper (or a lower) substrate 300 forms a closed structure 304 encircling a display region 302, wherein different pretilt angles are formed between the closed structure and the display region 302. The display region 302 can be a sub-pixel and an area thereof is, for example, from 50 μm×50 μm to 300 μm×300 μm, or can be a whole display region and an area thereof is, for example, from 5 mm×5 mm to 16 mm×16 mm, or even can be a greater area. A width of the closed structure region 304 is, for example, between 2-1000 μm. The above exposure polymerization region is determined according to the closed structure desired to be formed, and such step can be coordinate with utilization of a mask. The developing method can be solvent cleaning or laser etching. Finally, the upper substrate and the lower substrate are assembled. Now, if only one surface of the upper or the lower substrate has such closed structure, the region having the closed structure can form a HAN region, and if the surfaces of the upper and the lower substrates all have such closed structure, the region having the closed structure can form the HAN region, a VA region or a bend arrangement (Bend) region. A state of the liquid crystal molecules in the closed structure (referring to 304 of FIG. 3) is as that shown in FIG. 4.

Thereafter, referring to FIG. 2 again, in step 210, the OCB liquid crystal panel is driven by a multistage voltage variation mode. In the present invention, the multistage voltage variation mode can be described as follows. First, in step 202, a high voltage is applied to transfer the liquid crystal molecules within the OCB liquid crystal panel to a Bend or a VA state, wherein the high voltage is greater than 5V and less than 25V, which is preferably 10V.

Next, in step 204, the high voltage is decayed to a low voltage, wherein the low voltage is maintained above a bend state holding voltage of the OCB liquid crystal panel, wherein the bend state holding voltage is about between 1.5-4.5 V.

Finally, in step 206, the voltage is turned off to zero, so that the configuration of liquid crystal molecules within the OCB liquid crystal panel is maintained to a π-twist state.

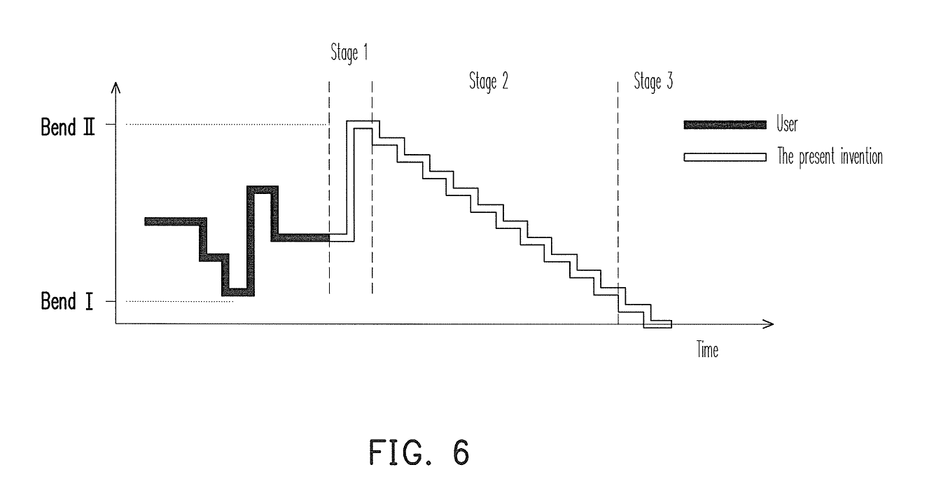

In the multistage voltage variation control of the step 210, the method of decaying the high voltage to the low voltage is not limited, which can be a step decay, a steep decay or a smooth decay, which are shown as FIGS. 5-7, wherein the horizontal axes represent the time, the vertical axes represent the voltages, the black solid lines represent operation stages of a user, and the white lines represent the multistage voltage variation control of the step 210.

Referring to FIG. 5, the circuit of the OCB liquid crystal panel can automatically perform the multistage voltage variation control of the present invention. First, a high voltage is applied (in step 202) and it is a relative voltage above a bend I state holding voltage. Next, this high voltage is steeply decayed to a low voltage above the Bend I state holding voltage (in step 204) within one minute and kept about 10 sec to 3 minutes. Thereafter, the voltage is decayed to zero, by which the configuration of liquid crystal molecules within the OCB liquid crystal panel is π-twisted, so that the liquid crystal molecules within the OCB liquid crystal panel are stably maintained to the π-twist state.

FIG. 6 is a diagram illustrating a step decay from the high voltage to the low voltage (step 204), and FIG. 7 is a diagram illustrating a smooth decay from the high voltage to the low voltage (step 204).

The method for manufacturing the above OCB liquid crystal panel can also be applied to a bistable liquid crystal panel, and the π-twist state is set a bright state and the splay state is set a dark state.

Moreover, as long as the multistage voltage variation control is once performed before shipment of the OCB liquid crystal panel from a manufacturing factory, the OCB liquid crystal panel can still be maintained to the π-twist state without a voltage being applied according to such driving method after the shipment.

In the following content, examples are performed to verify the effects of the present invention.

### EXAMPLE 1

The closed structure having the hybrid arrangement, the vertical arrangement or the bend arrangement property is respectively fabricated around a 16 mm×16 mm display region of a plurality of OCB liquid crystal panels, wherein a width of the closed structure is about 1 mm.

Thereafter, different driving methods are applied to drive the OCB liquid crystal panels, wherein a type of the utilized liquid crystal molecule is Chisso ZOC-5128XX.

First, after one of the OCB liquid crystal panels is driven to 20 Vpp (Bend II), the driving voltage is smoothly decayed to the bend state holding voltage, and a time for such stage is about 30 seconds. Then, the driving voltage is directly removed to obtain the OCB liquid crystal panel maintained to the π-twist state.

Next, after another one of the OCB liquid crystal panels is driven to 20 Vpp (Bend II), the driving voltage is decayed to the bend state holding voltage via the step decay, and a time for such stage is about 30 seconds. Then, the driving voltage is directly removed to obtain the OCB liquid crystal panel maintained to the π-twist state.

Next, after still another one of the OCB liquid crystal panels is driven to 20 Vpp (Bend II), the driving voltage is steeply decayed to 4.0V and is maintained for about 180 seconds. Then, the driving voltage is directly removed to obtain the OCB liquid crystal panel maintained to the π-twist state.

Thereafter, following experiments are performed on the above obtained OCB liquid crystal panels.

### (Stability Experiment at Room Temperature)

The OCB liquid crystal panel is stored under the room temperature for 240 hours, and it can still be maintained in the π-twist state according to observation.

### (Stability Experiment at High Temperature)

The OCB liquid crystal panel is stored under a temperature of 70 degrees centigrade for 24 hours, and it can still be maintained in the π-twist state.

The OCB liquid crystal panel is stored under a temperature of 80 degrees centigrade for 5 hours, and it can still be maintained in the π-twist state.

### (Stability Experiment at Low Temperature)

The OCB liquid crystal panel is stored under a temperature of −15 degrees centigrade for 24 hours, and it can still be maintained in the π-twist state.

### EXAMPLE 2

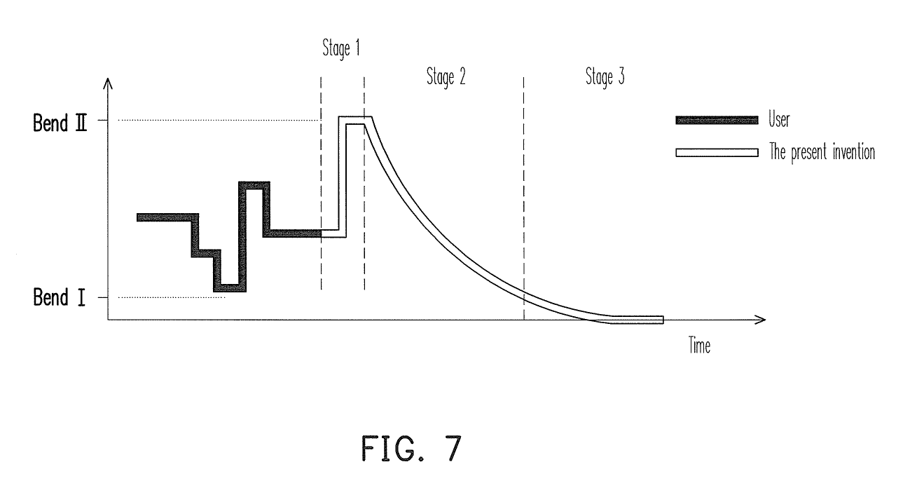

An OCB liquid crystal panel (the present invention) with a gap of 4 μm is fabricated according to the method of the Example 1. Then, a voltage-transmittance curve (V-T curve) of a 0-10 V section is measured. FIG. 8 is a diagram illustrating a V-T curve obtained according to the Example 2. According to FIG. 8, a feature of the V-T curve of the OCB liquid crystal panel of the present invention in the display region is overlapped to that of the conventional OCB liquid crystal panel, so it is known that the original splay state is changed to the π-twist state in the present invention, and the OCB liquid crystal panel of the present invention may have the same behavior in the display region with that of the original OCB liquid crystal panel.

### EXAMPLE 3

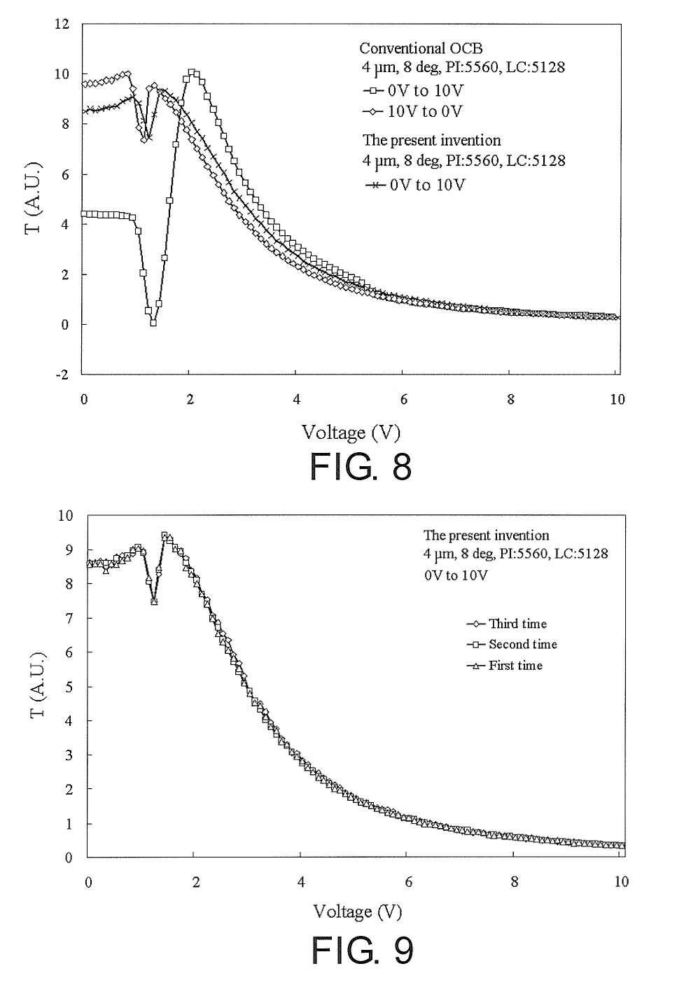

An OCB liquid crystal panel (the present invention) with the gap of 4 μm is fabricated according to the method of the Example 1. Then, the liquid crystal molecules are driven from 0V to 10V, and are changed back to the π-twist state, and such process is continually performed for 3 times. FIG. 9 is a diagram illustrating a V-T curve obtained according to the Example 3. According to FIG. 9, it is known that the three curves are overlapped, and no transition is occurred. Since the liquid crystal molecules are not transited and the feature curves of the display regions thereof are the same, all the peripheral related devices are unnecessary to be redesigned.

### EXAMPLE 4

A bistable liquid crystal panel is fabricated according to the method of the Example 1, wherein the splay state thereof is the dark state, the π-twist state thereof is the bright state, and a direction of a polarizer thereof is parallel to the alignment direction.

A simulation using the commercially available software was performed, the calculated contrast is up to 5000, and a viewing angle thereof reaches 160 degrees. Since a compensation film design is not applied to the simulation, if a suitable compensation film parameter is applied for the simulation, the viewing angle can be wider and more symmetric.

In summary, in the present invention, the structure design of the alignment surface and the specific driving method are applied to fabricate the closed structure surrounding the display area on the alignment-treated substrate surface, and perform the multistage voltage variation control after assembling of the substrates, so that the configuration of liquid crystal molecules of the display region can be stably kept in the π-twist state for a long time. Therefore, the relatively great transferring voltage is not required, and change of a thin-film transistor (TFT) design is unnecessary, which can be compatible to a current fabrication process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of manufacturing and driving an optically compensated birefringence (OCB) liquid crystal panel, comprising:
providing the OCB liquid crystal panel, wherein the OCB liquid crystal panel has a closed structure region having a hybrid arrangement (HAN), a vertical arrangement (VA) or a bend arrangement property around a display region of the OCB liquid crystal panel; and
driving the OCB liquid crystal panel by a multistage voltage variation mode, and the multistage voltage variation mode comprising:
applying a high voltage to transfer liquid crystal molecules in the OCB liquid crystal panel to a bend or a vertical arrangement state;
decaying the high voltage to a low voltage, wherein the low voltage is maintained above a bend state holding voltage of the OCB liquid crystal panel; and
turning off the voltage to zero to maintain a configuration of the liquid crystal molecules in the OCB liquid crystal panel in a π-twist state.

2. The method as claimed in claim 1, wherein the steps of providing the OCB liquid crystal panel comprises:
forming a reactive liquid crystal monomer layer on an alignment-treated surface of an upper substrate or a lower substrate;
performing an exposure polymerization and a development to the reactive liquid crystal monomer layer to form a closed structure, such that the closed structure and the display region of the OCB liquid crystal panel have different pretilt angles; and
assembling the upper substrate and the lower substrate, so that a region having the closed structure region forms a HAN region.

3. The method as claimed in claim 2, wherein a width of the closed structure region of the OCB liquid crystal panel is between 2-1000 μm.

4. The method as claimed in claim 1, wherein the steps of providing the OCB liquid crystal panel comprises:
forming a reactive liquid crystal monomer layer on a plurality of alignment-treated surfaces of an upper substrate and a lower substrate;
performing an exposure polymerization and a development to the reactive liquid crystal monomer layer to form a closed structure, so that the closed structure and the display region of the OCB liquid crystal panel have different pretilt angles; and
assembling the upper substrate and the lower substrate, so that a region having the closed structure region forms a HAN region, a VA region or a bend region.

5. The method as claimed in claim 4, wherein a width of the closed structure region of the OCB liquid crystal panel is between 2-1000 μm.

6. The method as claimed in claim 1, wherein an area of the display region of single pixel of the OCB liquid crystal panel is from 50 μm×50 μm to 16 mm×16 mm.

7. The method as claimed in claim 1, wherein the high voltage is greater than 5V and is less than 25V.

8. The method as claimed in claim 7, wherein the high voltage is about 10V.

9. The method as claimed in claim 1, wherein the method of decaying the high voltage to the low voltage comprises a step decay, a steep decay or a smooth decay.

10. The method as claimed in claim 1, wherein a time for decaying the high voltage to the low voltage is within one minute.

11. The method as claimed in claim 1, wherein the step of decaying the high voltage to the low voltage further comprises maintaining the low voltage for about 10 sec to 3 minutes.

12. The method as claimed in claim 1, wherein the bend state holding voltage of the liquid crystal molecules is between 1.5-4.5 V.

13. The method as claimed in claim 1 further comprising being used to fabrication of a bistable liquid crystal panel.
